(19) United States
(12) Patent Application Publication
(10) Pub. No.: US 2004/0176082 A1
(43) Pub. Date: Sep. 9, 2004

(54) Wireless communication systems

(76) Inventors: David Trevor Cliff, Bristol (GB); Rycharde Jeffery Hawkes, Bristol (GB); Colin Andrew Low, Wotton-Under-Edge (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/355,225

(22) Filed: Jan. 31, 2003

(30) Foreign Application Priority Data
Feb. 7, 2002 (DE) 0202820.7

(51) Int. Cl. H04M 3/42; H04Q 7/20

(52) U.S. Cl. 455/414.4; 455/422.1

(57) ABSTRACT

The present invention provides a wireless communication system (1) comprising a mobile station (2, 4), a server (8) for supporting a virtual environment (30), a sensor (28) remote from the mobile station (2, 4), which station for monitoring a variable and a communication network (6) for providing wireless communication between the mobile station (2, 4) and the virtual environment (30) and communication between the sensor (28) and the server (8), whereby the sensor output affects the virtual environment (30). A corresponding method is also disclosed.

The present invention relates to wireless communication systems and wireless communication methods.

Electronic games have become a growing part of the entertainment industry. More recently, such games have been provided for wireless communication devices, especially for mobile phones. Mobile phone games are available at varying levels of complexity depending upon, in particular, the bandwidth available and processing capabilities of the mobile phone itself. Such games permit a user to interact with a virtual environment. The virtual environment generally is maintained and operated by a remote device, typically a server. The user interacts with the virtual world through his/her mobile phone, which also provides the user with a window into the virtual environment, by text message, images, sounds or any combination thereof. Multiple users may interact with the virtual world, the activity of one user affecting the virtual environment for others.

In EP-A-1087323 there is disclosed a wireless communication system for interacting with a virtual environment to enable a multi-player interactive fiction game to be played. The virtual environment can be modified according to data acquired from a user's mobile phone. For instance, a fiction game may be set in the city in which the user is located.

However, to date, games playable over wireless communication systems just enable the virtual world to be interacted with and affected by users.

It is an aim of preferred embodiments of the present invention to provide a wireless communication system and method to broaden the scope of interactions with a virtual environment.

According to the present invention in a first aspect, there is provided a wireless communication system comprising a mobile station, a server for supporting a virtual environment, a sensor remote from the mobile station, which sensor for monitoring a variable and a communication network for providing wireless communication between the mobile station and the virtual environment and communication between the sensor and the server, whereby the sensor output affects the virtual environment.

Suitably, in which the virtual environment corresponds to a real world environment.

Suitably, the correspondence is topological.

Suitably, the system is configured whereby a user input on a mobile station controls the position of a first virtual agent in the virtual environment.

Suitably, position change of the mobile station in a real world environment corresponds to position change of a first virtual agent in the virtual environment.

Suitably, the first virtual agent is a virtual user.

Suitably, the likelihood of an event occurring in the virtual environment is varied depending upon the position of the first virtual agent in the virtual environment.

Suitably, there is a second virtual agent in the virtual environment, the behaviour of which second virtual agent is at least partly affected by the sensor output.

Suitably, the sensor monitors flow rates of physical objects.

Suitably, the sensor monitors the number of physical objects at a location.

Suitably, the physical objects are vehicles or people.

Suitably, the outputs from a plurality of sensors are used.

Suitably, a user input to a mobile station affects the likelihood of an event occurring in the virtual environment.

Suitably, the virtual environment is a fishing scenario.

Suitably, the virtual environment is an animal hunting or animal spotting scenario.

Suitably, the virtual environment is a bird watching scenario.

Suitably, the second virtual agent is an animal agent.

Suitably, the second virtual agent is a fish agent.

Suitably, the second virtual agent is a bird agent.

According to the present invention in a second aspect, there is provided a wireless communication method for a system comprising a mobile station and a server supporting a virtual environment, in which a sensor remote from the mobile station monitors a variable and the sensor output affects the virtual environment.

Suitably, the virtual environment corresponds to a real world environment.

Suitably, the correspondence is topological.

Suitably, a user input on a mobile station controls the position of a first virtual agent in the virtual environment.

Suitably, position change of the mobile station in a real world environment corresponds to position change of a first virtual agent in the virtual environment.

Suitably, the first virtual agent is a virtual user.

Suitably, the likelihood of an event occurring in the virtual environment is varied depending upon the position of the first virtual agent in the virtual environment.

Suitably, there is a second virtual agent in the virtual environment, the behaviour of which second virtual agent is at least partly affected by the sensor output.

Suitably, the sensor monitors flow rates of physical objects.

Suitably, the sensor monitors the number of physical objects at a location.

Suitably, the physical objects are vehicles or people.

Suitably, the outputs from a plurality of sensors are used.

Suitably, a user input to a mobile station affects the likelihood of an event occurring in the virtual environment.

Suitably, the virtual environment is a fishing scenario.

Suitably, the virtual environment is an animal hunting or animal spotting scenario.

Suitably, the virtual environment is a bird watching scenario.

Suitably, the second virtual agent is an animal agent.

Suitably, the second virtual agent is a fish agent.

Suitably, the second virtual agent is a bird agent.

The present invention will now be described, by way of example only, with reference to the drawings that follow; in which:

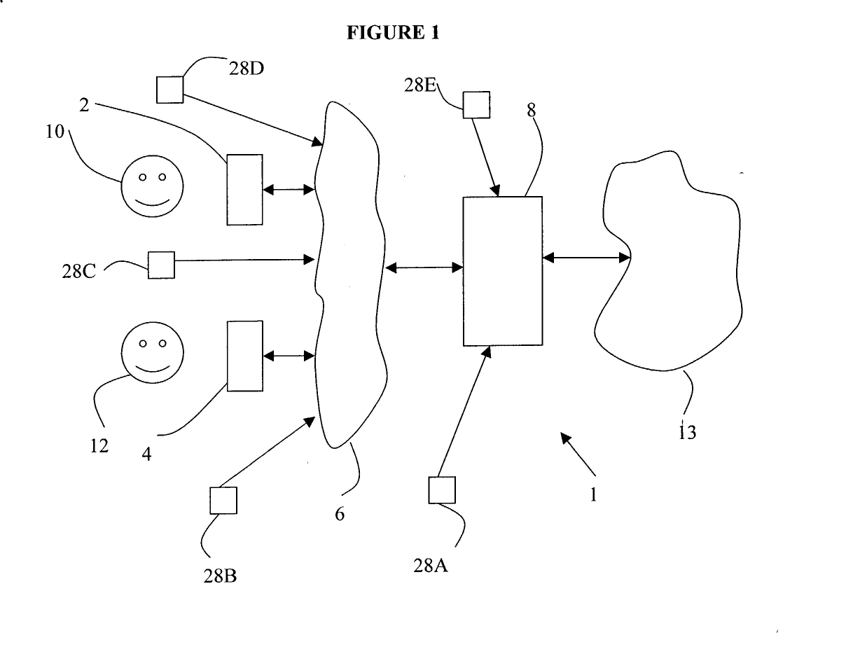

FIG. 1 is a schematic illustration of system elements of an embodiment of the present invention.

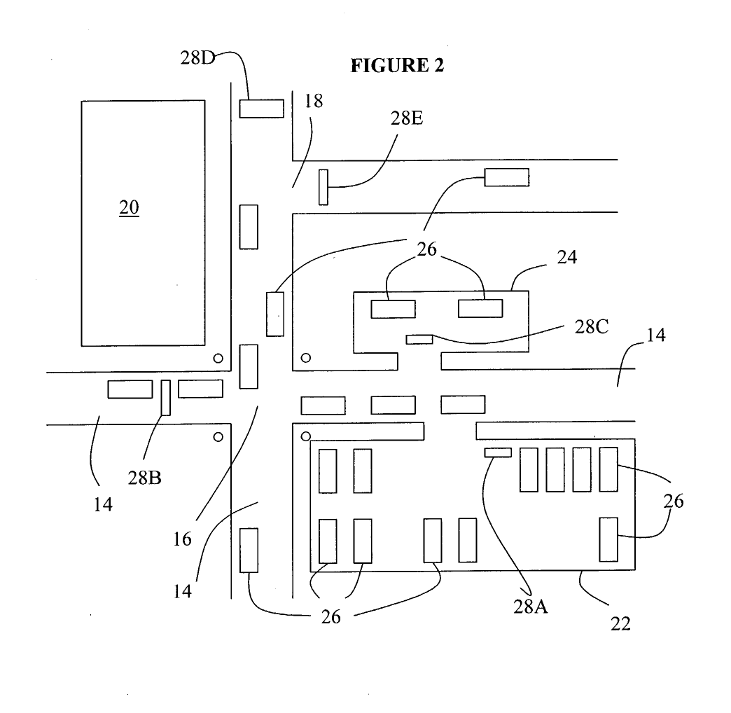

FIG. 2 is a schematic illustration of a real world environment.

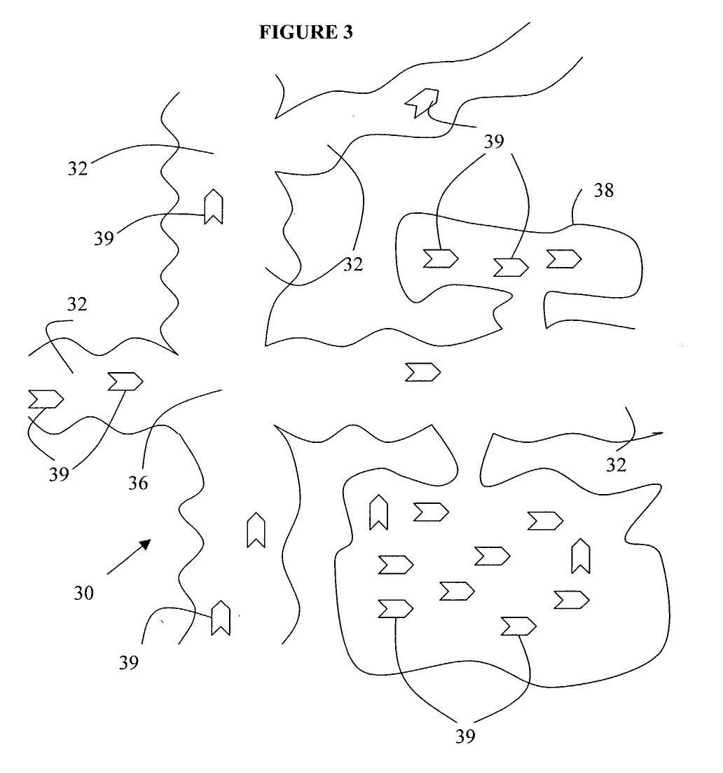

FIG. 3 is a schematic illustration of a virtual environment for use with this embodiment of the present invention.

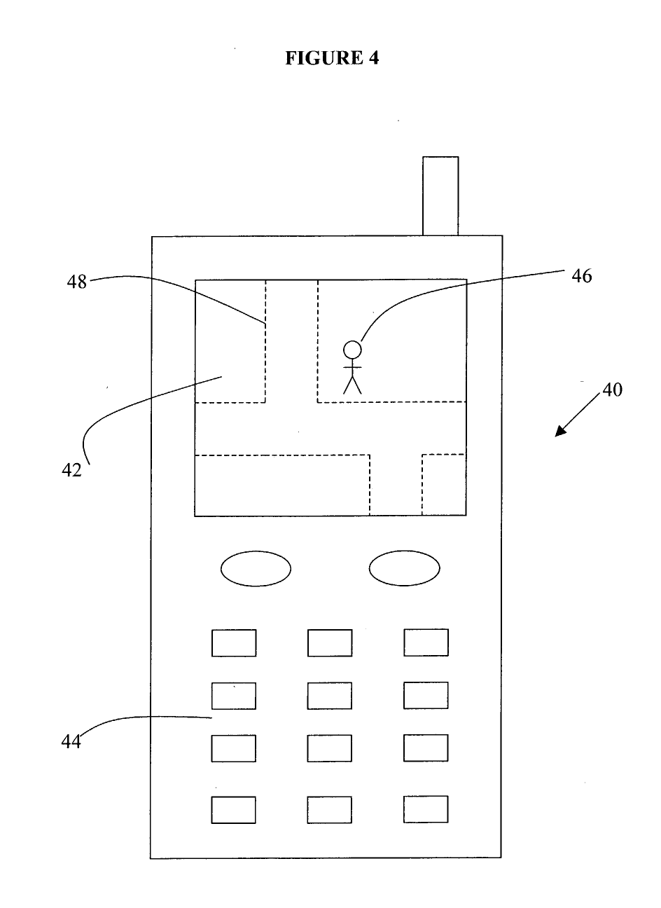

FIG. 4 is a schematic illustration of a mobile phone configured for use with the present invention.

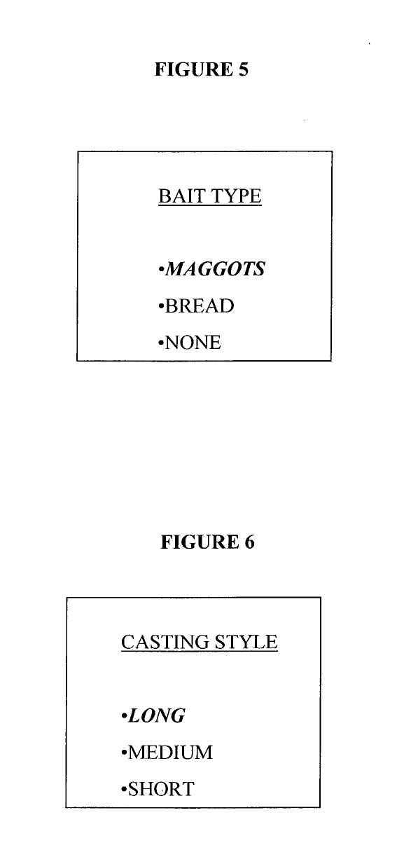

FIGS. 5 and 6 are schematic illustrations of messages appearing on a mobile phone display as part of an embodiment of the present invention.

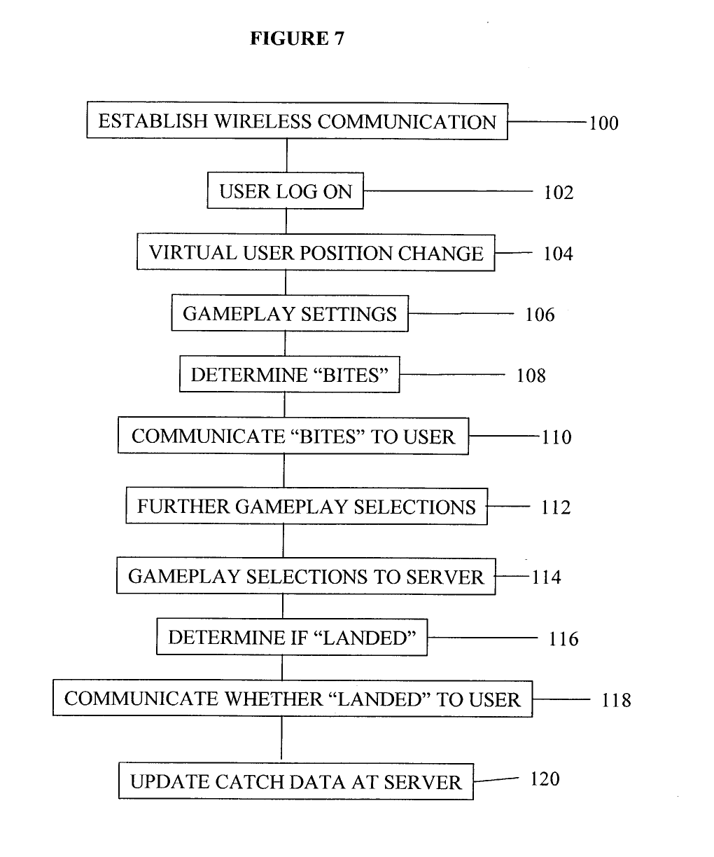

FIG. 7 is a functional diagram showing an embodiment of the present invention.

Referring to FIG. 1 of the drawings that follow there is shown a wireless communication system 1 comprising a first mobile station 2, a second mobile station 4 and a wireless communication network 6. Typically these elements are embodied in a mobile phone network. Communication network 6 is connected to a server 8. Each mobile station 2, 4 is used by a corresponding user 10, 12, respectively.

The server 8 is configured to support a virtual environment paradigm indicated schematically at 13.

Referring to FIG. 2 of the drawings that follow, there is shown a representative, real word environment comprising a plurality of streets 14, a traffic light junction 16 and a T-junction 18. Off the streets 14 is a shopping centre (or mall) 20, a car park 22, and a drive-through fast-food restaurant 24. Vehicles, such as cars, lorries, motorbikes, bicycles etc, a plurality of which is represented schematically as 26, flow along the streets 14.

Sensors 2A-28E monitor vehicle density and/or speeds. The sensors 28 may be of different types and need not measure these variables directly. For instance, sensor 28A may monitor the number (and optionally type) of vehicles entering car park 22. Such systems are relatively common to provide dynamic information to road users about the number of spaces available in a given car park. It may then be assumed that the average speed of vehicles in the car park is relatively low so a direct monitor of vehicle speed need not be made for car park 22.

Sensor 28B may be a sensor used to control the traffic lights at junction 16. Other sensors 28C-28E may be used for other traffic flow monitoring and/or be specifically installed for use with embodiments of the present invention.

Vehicle density may be very high in car park 22, with low speeds and medium density in a drive-through restaurant 24, with medium speeds. On street 14 vehicle density and speeds will vary. For instance, at the approach to traffic light junction 16, vehicle density and speed will vary depending on time of day and the present state of the traffic light cycle. Vehicle density in side streets, such as that terminating in T-junction 18, may be low, but the vehicle speeds may be higher.

Sensor data is transmitted to the server for subsequent use. The data can be transmitted by wireless transmission or over a physical transmission line. As shown in FIG. 1, the sensors 28 may communicate with the server direct (eg 28A, 28E) or via a distributed electronic network such as the internet 6 (eg 28B, 28C, 28D).

Referring to FIG. 3 of the drawings that follow, there is a virtual environment 30 corresponding topologically to the real world environment of FIG. 2. In this embodiment the virtual environment 30 is to be used for a fishing simulation, so the roads 14 are mapped to rivers or streams 32, the car park 22 to a large lake 34, the traffic light junction 16 to a confluence 36 and the drive-through restaurant to a small lake 38. The rivers 32, large lake 34, confluence 36, and small lake 38 are aquatic zones in this virtual environment, the other area away from the aquatic zones being virtual dry land from which virtual fishing can be undertaken.

In the aquatic zones are autonomous fish agents 39 the movement of which in the virtual environment is controlled by the server 8.

The data from sensors 28 is used, in some cases with assumptions, to determine the vehicle density and vehicle speed at a given location. From this the autonomous fish agents 39 in the virtual environment 30 are dynamically affected. The table below gives an indication of how variables affecting the autonomous fish agents 39 may be determined.

| Vehicle | Vehicle | Fish | Fish | Fish | Fish |
|---|---|---|---|---|---|
| Density | Speed | Type | Density | Activity | Hunger |
| High | High | A | Medium | High | 80% |
| High | Low | A | High | Low | 60% |
| Medium | High | B | Medium | High | 65% |
| Medium | Low | C | Low | Low | 42% |
| Low | High | D | Very Low | High | 53% |
| Low | Low | D | Low | Low | 25% |

The greater the fish density the more likely a fish is to be caught. Similarly, the higher the fish hunger and lower the fish activity the more likely a fish is to be caught. Other variables can be used to modify the likelihood of a fish being caught. For instance, a particular bait or fly selected by a user may vary the likelihood of a fish being caught in a given virtual situation.

A given autonomous fish agent 39 has its activity and characteristics determined, at least in part by the variables calculated dynamically from the real world variables monitored by sensors 28. Additional random elements are added to fish agent behaviour calculations to avoid entirely deterministic behaviour.

The way in which the real world variables from sensors 28 are used to generate data to govern the virtual environment can be selected readily and is a matter of design choice.

Further or other variables can be used, for instance, local rainfall data can be used to vary the amount of water in the virtual aquatic environment.

In one embodiment of the present invention, a user 10 positions a virtual user agent of himself in the virtual environment using his mobile.

Referring to FIG. 4 of the drawings that follow there is shown, schematically, a mobile phone mobile station 40 comprising a display 42 and a keypad 44 as is well known in the art. To navigate in the virtual environment 30 the user 10 can be represented on display 42 by a character 46 (virtual user) on an overlaid virtual map 48 of part of the virtual environment 30.

Once the virtual user character 46 has reached the desired virtual position, fishing can commence. The user 10 may be offered options as to his fishing style, baits, weights, flys etc, (see FIGS. 5 and 6 of the drawings that follow, by way of example). Once a position and fishing variables have been selected the game server 8 calculates the chances of an autonomous fish agent 39 being caught by the user. If such a fish is caught a corresponding Short Messaging Service (SMS) text message is sent to the user.

Optionally, when a fish agent 39 is caught further style selections can be made by the user 10 to be used by the game server 8 to determine whether an autonomous fish agent 39 is reeled in successfully.

Thus, users 10, 12 can position their virtual selves in the virtual environment 30 according to observed variables in the real environment.

In an alternative embodiment, the mobile station 2 is location aware. For instance, if the mobile station 40 is a mobile phone, the location awareness may be determined by Enhanced Observed Time Delay (EOTD) calculations. Alternatively, the mobile station may incorporate global satellite positioning apparatus for location awareness. In this case, the location of the user 10 in the virtual environment 30 can be determined from the corresponding location of the user 10 in the real world environment. For instance, if the user 10 walks from traffic light junction 16 to car park 22 (A to B in FIG. 2) in the real environment, the corresponding virtual user character 44 moves from the confluence to the large lake (A′ to B′ in FIG. 3). Otherwise, fishing is undertaken as above.

An example of a method according to embodiments of the present invention is described in relation to the functional flow diagram of FIG. 7.

At step 100 the user 10 establishes wireless communication with the communication network 6 via user's mobile station 2. At step 102 the user logs into the virtual environment 30 provided by the server 8. At step 104 the user 10 changes the position of a virtual user character 44 in the virtual environment 30. The change of position of the virtual user 44 can be by the user communicating position change instructions via his mobile station 2, or by the user 10 moving in the real environment corresponding to the virtual environment 30. In step 106 the user 10 sets up their gameplay parameters such as fishing style, bait type, fly type etc and this gameplay information is communicated to the server 8 via the communication network 6 for instance using SMS. In step 108 the server 8 determines on an ongoing basis whether any of the logged on users 10, 12 has a biting fish. As described above, the server 8 models behaviour of autonomous fish agents 39 using, at least in part, data output from sensors 28 which data affects the likelihood of an event occurring in the virtual environment; in this case a fish bite of an autonomous fish agent 39. If a user 10 has a fish agent 39 bite this is communicated to the user in step 110, for instance using SMS. The user 10 may then be required, in step 112, to make further gameplay selections to determine whether the catch is landed. For instance, a user 10 may be required to indicate whether the reeling in will be fast or slow. This further gameplay information is communicated to the server 8 (step 114), which determines whether the fish agent 39 is landed (step 116) and communicates the result to the user 10 (step 118). The user catch data is then updated on the server 8 in step 120. In optional modifications, software agents in the virtual environment may represent different fish types the behaviour of which can be modelled according to how such fish species behaves in a corresponding real environment. Variable points may be awarded to users depending on the difficulty of catching and landing a given fish species.

The performance of users is recorded at the game server 8 enabling a competitive table to be set up. Further, chat rooms may be provided to enable users to exchange information.

The system is described in relation to one or two users, but it will be appreciated that any number of users can take part. If two users are in the same virtual vicinity they may interfere with each other's fishing (generally to reduce the chance of a catch).

In alternative embodiments correspondence between the real environment and the virtual environment may not be topological, or may be only partly so. For instance, the virtual environment may be fictional or based on an environment other than that in which the user is present in the real environment and the user simply must find good locations by trial and error.

The real world variables on which the virtual environment agent behaviour is at least in part based need not be traffic flow. Any monitorable real word variable can be used. By way of example, the flow of shoppers in mall 20 can be used to modify virtual environment agent behaviour.

For preferred embodiments of the present invention, the real world environment can be mapped to a virtual environment whereby physical movement of a user in the real world environment can be mapped correspondingly to movement of the virtual user in the virtual environment.

Applications of the present invention need not be restricted to fishing games. For instance, a butterfly catching game, an animal hunting/spotting game or a bird-watching game can be played. Alternatively, it can be just a simple point scoring game without a “sports” scenario embodied using the principles of the present invention.

The present invention is not restricted to users with mobile phones. For instance, wireless internet personal digital organisers, preferably with GPS, can be used. Communication with users can be as synchronous methods other than SMS.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A wireless communication system comprising a mobile station, a server for supporting a virtual environment, a sensor remote from the mobile station, said sensor being arranged for monitoring a variable, and a communication network for providing wireless communication between the mobile station and the virtual environment and communication between the sensor and the server, the server being arranged for causing the sensor output to affect the virtual environment.

2. A wireless communication system according to claim 1, in which the virtual environment corresponds to a real world environment.

3. A wireless communication system according to claim 2, in which the correspondence is topological.

4. A wireless communication system according to claim 1, wherein the mobile station includes a user input for controlling the position of a first virtual agent in the virtual environment.

5. A wireless communication system according to claim 1, wherein the server is arranged for causing a position change of a first virtual agent in the virtual environment in response to a position change of the mobile station in a real world environment.

6. A wireless communication system according to claim 4, wherein the server is arranged for causing the first virtual agent to be a virtual user.

7. A wireless communication system according to claim 4, wherein the server is arranged for causing the likelihood of an event occurring in the virtual environment to be varied in response to the position of the first virtual agent in the virtual environment.

8. A wireless communication system according to claim 1, wherein the server is arranged for causing a second virtual agent to be in the virtual environment and for causing the behaviour of the second virtual agent to be at least partly affected by the sensor output.

9. A wireless communication system according to claim 1, wherein the sensor is arranged for monitoring flow rates of physical objects.

10. A wireless communication system according to claim 1, in which the sensor is arranged for monitoring the number of physical objects at a location.

11. A wireless communication system according to claim 9, wherein the physical objects are at least one of vehicles and people.

12. A wireless communication system according to claim 1, further including a plurality of the sensors for deriving outputs, the server being arranged for causing the outputs from the plurality of sensors to be used in the virtual environment.

13. A wireless communication system according to claim 1, wherein the server is arranged for causing a user input to a mobile station to affect the likelihood of an event occurring in the virtual environment.

14. A wireless communication system according to claim 1, in which the virtual environment is a fishing scenario.

15. A wireless communication system according to claim 1, in which the virtual environment is at least one of an animal hunting and animal spotting scenario.

16. A wireless communication system according to claim 1, in which the virtual environment is a bird-watching scenario.

17. A wireless communication system according to claims 8, in which the second virtual agent is an animal agent.

18. A wireless communication system according to claim 14, in which the second virtual agent is a fish agent.

19. A wireless communication system according to claim 16, in which the second virtual agent is a bird agent.

20. A wireless communication method in a system including a mobile station, a server supporting a virtual environment and a sensor remote from the mobile station, the method comprising causing the server to affect the virtual environment in response to a variable monitored by the sensor.

21. A wireless communication method according to claim 20, in which the virtual environment corresponds to a real world environment.

22. A wireless communication method according to claim 21, in which the correspondence is topological.

23. A wireless communication method according to claim 21, wherein the mobile station controls the position of a first virtual agent in the virtual environment in response to a user input.

24. A wireless communication method according to claim 20, in which position change of the mobile station in a real world environment corresponds to position change of a first virtual agent in the virtual environment.

25. A wireless communication method according to claim 23, in which the first virtual agent is a virtual user.

26. A wireless communication method according to claim 23, further including varying the likelihood of an event in response to the position of the first virtual agent in the virtual environment.

27. A wireless communication method according to claim 20, wherein there is a second virtual agent in the virtual environment, at least partly affecting the behaviour of the second virtual agent in response to the sensor output.

28. A wireless communication method according to claim 20, wherein the sensor monitors flow rates of physical objects.

29. A wireless communication method according to claim 20, wherein the sensor monitors the number of physical objects at a location.

30. A wireless communication method according to claim 28, in which the physical objects are at least one of vehicles and people.

31. A wireless communication method according to claim 20, wherein there is a plurality of the sensors, and using the outputs from the plurality of sensors in the virtual environments.

32. A wireless communication method according to claim 20, further including causing a user input to a mobile station to affect the likelihood of an event occurring in the virtual environment.

33. A wireless communication method according to claim 20, in which the virtual environment is a fishing scenario.

34. A wireless communication method according to claim 20, in which the virtual embodiment is at least one of an animal hunting and animal spotting scenario.

35. A wireless communication method according to claim 20, in which the virtual environment is a bird watching scenario.

36. A wireless communication method according to claim 27, in which the second virtual agent is an animal agent.

37. A method of communicating with a communication network, a sensor, a mobile station remote from the sensor and a computer arrangement establishing a virtual environment, comprising coupling a first signal derived by the sensor to the computer arrangement, causing the computer arrangement to affect the virtual environment in response to the first signal being coupled to the computer arrangement, and communicating second signals between the computer arrangement and the mobile station via the network, the second signals affecting at least one of the virtual environment and the mobile station.

38. The method of claim 37, wherein the first signal is coupled to the computer arrangement via the network.

39. The method of claim 37, wherein the first signal is coupled to the computer arrangement without going through the network.

40. The method of claim 37, wherein the second signals affect both the virtual environment and the mobile station.

41. A system for communicating comprising a communication network, a sensor, a mobile station remote from the sensor and a computer arrangement for establishing a virtual environment, the system being arranged for: (a) coupling a first signal derived by the sensor to the computer arrangement, (b) causing the computer arrangement to affect the virtual environment in response to the signal coupled to the computer arrangement, (c) communicating second signals between the computer arrangement and the mobile station via the network, and (d) causing the second signals to affect at least one of the virtual environment and the mobile station.

42. The system of claim 41 wherein the system is arranged for causing the first signal to be coupled to the computer arrangement via the network.

43. The system of claim 41 wherein the system is arranged for causing the first signal to be coupled to the computer arrangement without going through the network.

44. The system of claim 41 wherein the system is arranged for causing the second signals to affect both the virtual environment and the mobile station.
